(19) United States
(12) Patent Application Publication
(10) Pub. No.: US 2005/0096119 A1
(43) Pub. Date: May 5, 2005

(54) Method, apparatus, and program product for conducting bingo games with pre-assigned bingo cards and pre-matched bingo card sets

(76) Inventors: Clifton Lind, Austin, TX (US); Jefferson Craig Lind, Austin, TX (US)

Correspondence Address: Russell D. Culbertson, Suite 420, 1114 Lost Creek Blvd., Austin, TX, 78746, US

(21) Appl. No.: 10/726,979

(22) Filed: Dec. 3, 2003

Related U.S. Application Data
(60) Provisional application No. 60/515,289, filed on Oct. 29, 2003.

(51) Int. Cl. A63F 13/00

(52) U.S. Cl. 463/19

(57) ABSTRACT

A method according to the present invention includes matching bingo card representations to a given set of game designations to produce a matched card set. Each matched bingo card representation in the matched card set represents a respective game play record for use in the present gaming system and includes or is associated with a result indicator that indicates whether the respective bingo card representation is a winning card or losing card for that set of game designations. Individual game play records from the matched card set are each assigned to a player in response to a game play request initiated by the player. Each game play request is associated with a player by virtue of the player initiating the game play request. Each game play request is also associated with a particular card representation that is “owned” or held by the player. Players are assigned one or more card representations to allow the player to make game play requests.

### CROSS-REFERENCE TO RELATED APPLICATION

The Applicants claim the benefit, under 35 U.S.C. §119(e), of U.S. Provisional Patent Application 60/515,289 filed Oct. 29, 2003 and entitled METHOD, APPARATUS, AND PROGRAM PRODUCT FOR CONDUCTING BINGO GAMES WITH PRE-ASSIGNED BINGO CARDS AND PRE-MATCHED BINGO CARD SETS. The entire content of this provisional application is incorporated herein by this reference.

### TECHNICAL FIELD OF THE INVENTION

This invention relates to gaming and gaming systems. More particularly, the invention relates to a bingo-type gaming system in which a set of bingo card representations is pre-matched to produce a set of game play records which are later assigned to players holding cards from the set of bingo card representations. The invention encompasses a method of awarding results in a bingo game and an apparatus and program product for implementing the gaming system.

### BACKGROUND OF THE INVENTION

Bingo-type games are played with predefined bingo cards that each include a number of bingo designations such as Arabic numerals randomly arranged in a desired manner, commonly in a grid. The bingo designations on the cards are selected from a pool of available designations. In more traditional bingo-type games the cards are physically printed on paper or other suitable material. These traditional printed cards are purchased by players prior to the start of a game. Once all the cards for a game have been purchased, designations from the available pool of designations are selected at random. As the designations are selected and announced in the game, the players match the randomly selected designations with the designations printed on their respective card or cards. This matching and marking of matched designations on the bingo card is commonly referred to as “daubing” the card. The player first producing a predetermined pattern of matches between the randomly selected designations and the printed card designations on a single card, and then announcing “bingo” to claim the win, is considered the winner. Consolation prizes may be awarded to players having cards matched to produce consolation prize patterns at the time of the winning pattern.

There are numerous variations on the traditional bingo game. Some bingo-type games perform a draw to produce a set of designations prior to the sale of printed bingo cards. These bingo-type games use printed cards like regular printed bingo cards, but with the card face concealed in some fashion. Once a player purchases one of these covered face bingo cards, the player can reveal the card face and match the drawn designations to the printed card designations to determine if the matched designations produce some predetermined winning pattern.

Another variation of the traditional bingo game is played with electronic bingo card representations rather than the traditional printed bingo cards. In these bingo-type games, each bingo card is represented by a data structure that defines the various card locations and designations associated with the locations. The game is played through player stations connected via a communications network. A central computer system in the network may be responsible for storing the bingo card representations and distributing or communicating bingo card representations to players at the player stations. The player stations display the bingo cards defined by the card representations and also allow the players to daub or mark designation matches as game designations are announced in the game. A primary advantage of this electronic bingo game is that the games may be played at a much faster pace than is practical with traditional paper bingo. Another advantage of this electronic version of bingo is that the games can be administered and controlled from a remote location and actually played at a number of different bingo establishments.

Another electronic bingo gaming system is disclosed in U.S. patent application Ser. No. 10/028,889, filed Dec. 20, 2001, and entitled “Method and Program Product for Producing and Using Game Play Records in a Bingo-Type Game,” and in U.S. provisional patent application Ser. No. 60/265,100, filed Jan. 30, 2001 and entitled “Object Draw Gaming System and Program Product.” The entire content of each of these applications is incorporated herein by this reference. In the bingo system described in these applications, a set of bingo card representations is pre-matched with a set of bingo designations to create a matched card set. The matched card set includes a data record corresponding to each matched card and this data record includes an indicator of the result achieved by the card upon matching the card with the set of bingo designations. These game records are assigned to players in the gaming system in response to player requests.

Traditional bingo games, either played with paper cards or electronic card representations are limited in the manner in which the results of a game may be displayed. In order to maintain player interest in the game, it is desirable to have an option of displaying results to the players in a variety of different fashions. It is also desirable to further increase the speed at which bingo-type games may be played. Yet it is essential that the game retain the basic characteristics of a bingo-type game, namely that the game is played with predefined cards or card representations which are matched or daubed against randomly generated designations, and the game winner is the first player to match the designations in a predetermined winning pattern on his or her card or card representation.

### SUMMARY OF THE INVENTION

A gaming system embodying the principles of the present invention utilizes a game designation generating component, a gaming establishment component, and at least one set of predefined card representations. Each card representation is a representation of a bingo card stored in electronic format as a data structure or data record defining a predefined pattern (often but not necessarily a grid) of game designations chosen from a pool of available designations. The game designations associated with a given card representation may be referred to as card designations. The game designation generating component generates sets of game designations from a pool of available designations. Results for each card representation for a particular game are identified by matching the card designations for the respective card representation to a game designation set produced for that game. This matching of card designations for the respective card representations in a card set to a game designation set will be referred to in this disclosure and the accompanying claims as “matching a game designation set with a card representation set.” A card representation that matches a given game designation set in a predetermined game ending pattern is considered a game ending card or game ending winner for the given game designation set and may commonly be associated with some prize. Card representations that match the given set of game designations in other predetermined patterns under a given set of matching rules may also be considered winning cards and may be awarded other prizes.

A method according to the present invention includes matching the card representations to a given set of game designations to produce a matched card set. Each matched bingo card representation in the matched card set represents a respective game play record for use in the present gaming system. The matched card set thus includes a number of game play records, each corresponding to a different one of the bingo card representations. Each game play record in the matched card set includes or is associated with a result indicator that indicates whether the respective bingo card representation is a winning card or losing card for that set of game designations. The game play record associated with a card representation that achieves a game ending pattern for a given designation set is considered a game ending game play record.

Individual game play records from matched card set are assigned to players in response to game play requests initiated by the players. Each game play request is associated with a player by virtue of the player initiating the game play request. Each game play request is also associated with a particular card representation that is “owned” or held by the player. Players are assigned one or more card representations to allow the player to make game play requests. The card representations are assigned to the player preferably in the form of some physical media as either a data structure, card representation identifier, a printed representation of the card, or some combination of these. Card representations may be assigned to a player at the beginning of a gaming session for the player, immediately prior to each game play request or as part of initiating a game play request, or at other times within the scope of the present invention. For example, one or more card representations may be permanently assigned to a player and the player may use the card representation or representations in numerous different gaming sessions over a period of hours, days, months, or longer.

In the play of a bingo-type game according to the invention, a set of game designations is determined by the game designation generating component. A processing device included in the gaming establishment component matches the set of bingo card representations to the set of game designations provided by the game designation generating component and preferably stores the resulting matched card set. The matched card set is stored in a secure fashion so that no one can see the results of the pre-matching and thus the result associated with any game play record in the set.

Once the matched card set is created and ready for play, a player at the gaming establishment component may purchase or otherwise request a game play record from the set through a player station included in the gaming establishment component. That is, in response to a game play request initiated by the player at a player station, the player is assigned a game play record from the respective matched card set. The game play record that is assigned for a given game play request is the game play record from the matched card set that corresponds to the card representation that is associated with the requesting player for the respective game play request. Thus, the assignment of a game play record to a player is representative of the player playing a bingo game and obtaining the result for the bingo game for the card that the player has obtained for play of the game. The information that the player station actually receives in response to a game play request is sufficient to allow the player station to display the result associated with the game play record, that is, the result of matching the respective card representation to the given set of game designations. If the card representation associated with the game play request matches the game designations to produce one of the predetermined winning patterns, the player receives credits or winnings. However, if the card representation associated with the game play request does not match the game designations to produce one of the predetermined winning patterns, the player receives no winnings or credits.

Because each matched card set will have only a single a game play result corresponding to each respective card representation, once a player that is associated with a given card representation has been assigned a game play result from a given matched card set, that matched card set is exhausted with respect to that card representation. That is, there will then be no further game play records remaining in that matched card set to assign for a game play request associated with that particular card representation. Thus, in order to allow a player to continue to play with their associated card representation, the present invention supplies additional matched card sets, preferably in one of two ways. The first preferred manner in which the system may make additional matched card sets available to the players is by maintaining a number of active matched card sets from which game play records may be assigned in response to game play requests. Once a game play record for a given card representation has been assigned from a first matched card set, the next game play request associated with that card representation is assigned from an additional matched card set. The first matched card set remains active for assigning game play records corresponding to other card representations that have not thus far been associated with a game play request.

The second preferred manner in which the system may make additional matched card sets available to the players is by maintaining a given matched card set available for play for only a limited amount of time, and then repeatedly making a new matched card set available for assignment of game play records at short intervals. The intervals in which matched card sets are made available for play, that is, for assignment of game play records, is kept short enough to prevent a game player from having to wait to make a game play request associated with a given card.

Regardless of the manner in which matched card sets are made available for play, a game according to the invention, that is, a game using a single matched card set, may end once a player (a game winning player) has received or has been assigned a game play record corresponding to a card representation matched to produce a particular predetermined game ending pattern. Thus, the game ending pattern sets the criteria for ending a bingo-type game pursuant to the invention.

### BRIEF DESCRIPTION OF THE DRAWINGS

FIG. 1 is a diagrammatic representation of a gaming system embodying the principles of the invention.

FIG. 2 is a diagrammatic representation of an alternate gaming system embodying the principles of the invention.

FIG. 3 is a diagrammatic representation of a gaming establishment component according to one form of the present invention.

FIG. 4 is a diagrammatic representation of the point-of-sale terminal and player station included in one preferred form of the present gaming system.

FIG. 5 is a representation of a game card used in the present invention.

FIG. 6 is a flow chart showing the process steps associated with the overall play of a game embodying the principles of the present invention.

FIG. 7 is a flow chart showing process steps associated with the operation of the point-of-sale terminals.

FIG. 8 is a flow chart showing process steps associated with the operation of the player stations.

FIG. 9 is a flow chart showing process steps at the central computers.

FIG. 10 is a diagrammatic representation of a portion of the data representing a matched card set according to one preferred form of the present invention.

### DESCRIPTION OF PREFERRED EMBODIMENTS

The claims at the end of this application set out novel features which the Applicants believe are characteristic of the invention. The various advantages and features of the invention together with preferred modes of use of the invention will best be understood by reference to the following description of illustrative embodiments read in conjunction with the accompanying drawings.

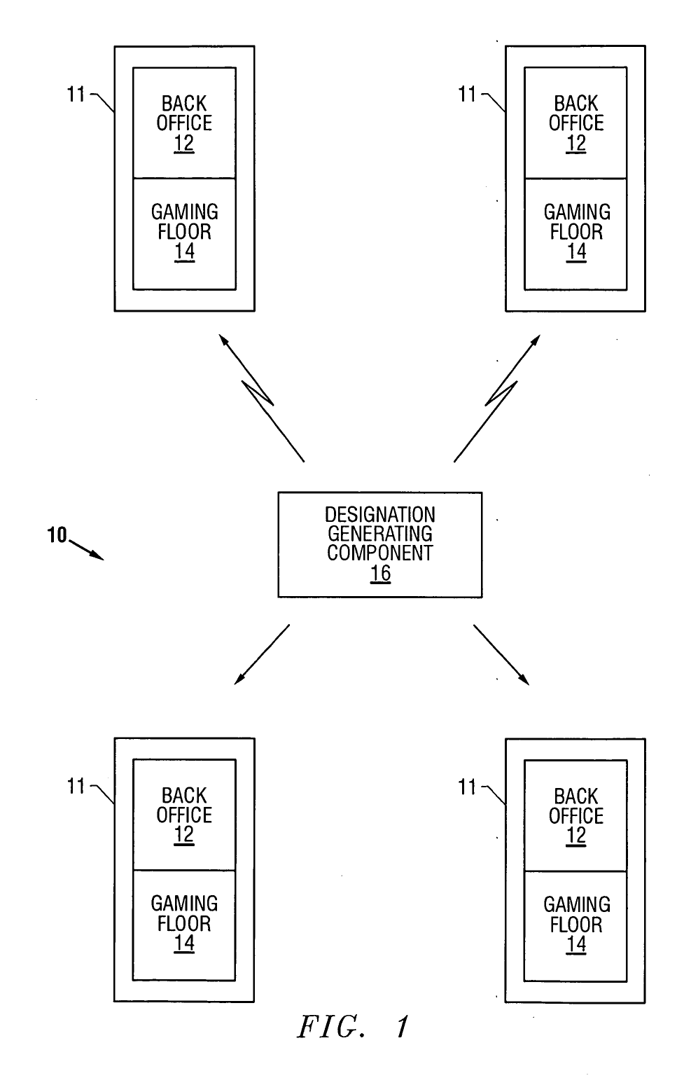

Referring to FIG. 1, a gaming system 10 embodying the principles of the invention includes at least one and preferably many gaming establishment components 11 each having a back office system 12 and a gaming floor or casino floor system 14. Gaming system 10 also includes a designation generating component 16 in communication with each gaming establishment component 11. Gaming floor system 14 is accessible to the public and allows players to establish and modify accounts in gaming system 10. Players also use gaming floor system 14 to participate in various games available through gaming system 10. Back office system preferably 12 maintains accounts and account balances for players, maintains account information, and provides system usage reports and other reports useful in managing gaming activities at the particular gaming establishment component 11. Each back office system 12 also matches electronic bingo cards (card representations) to sets of game designations, stores the matched card sets, and assigns the game play records from the matched card sets in response to player requests made through the respective gaming floor system 14.

For each game played according to the invention, designation generating component 16 produces a series or set of game designations and communicates the set of game designations to the various gaming establishment components 11. In one preferred form of the invention, designation generating component 16 includes an automated ball draw system which automatically draws a desired number of balls or other objects from a group of such objects. Each object is associated with a designation so that the series of objects drawn by the device identifies or defines a set of game designations. Alternatively to the object draw device, designation generating component 16 may comprise any suitable arrangement for generating designations at random from a pool of available designations to produce the desired set of game designations. Regardless of how the set of game designations is produced, the resulting set of designations is communicated to the gaming establishment components 11. A secure communications arrangement is used to provide communications from designation generating component 16 to the various gaming establishment components 11.

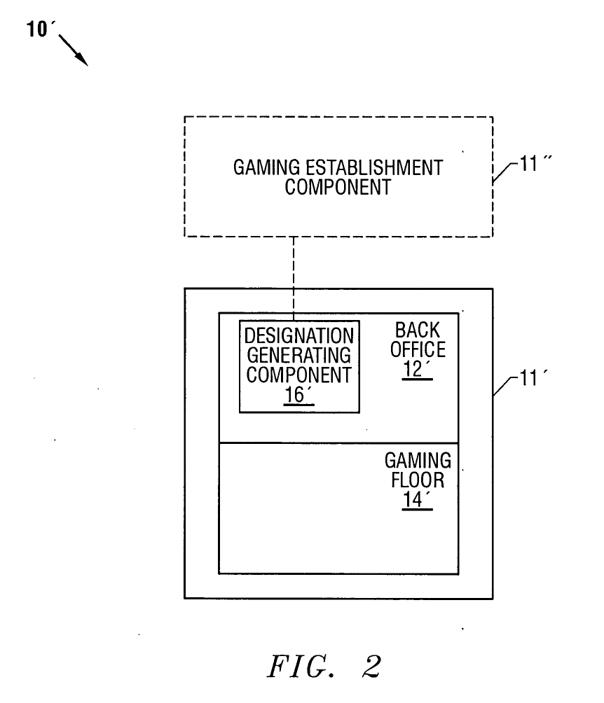

FIG. 2 shows an alternate gaming system embodiment 10′. In this form of the invention, designation generating component 16′ is dedicated to a single gaming establishment component 11′. In particular, designation generating component 16′ is implemented as part of the back office system 12′ for gaming establishment component 11′. As a further alternative arrangement, designation generating component 16′ may be connected to communicate sets of game designations not only to the local gaming establishment component 11′, but also to another gaming establishment component 11″ shown in dashed lines in FIG. 2.

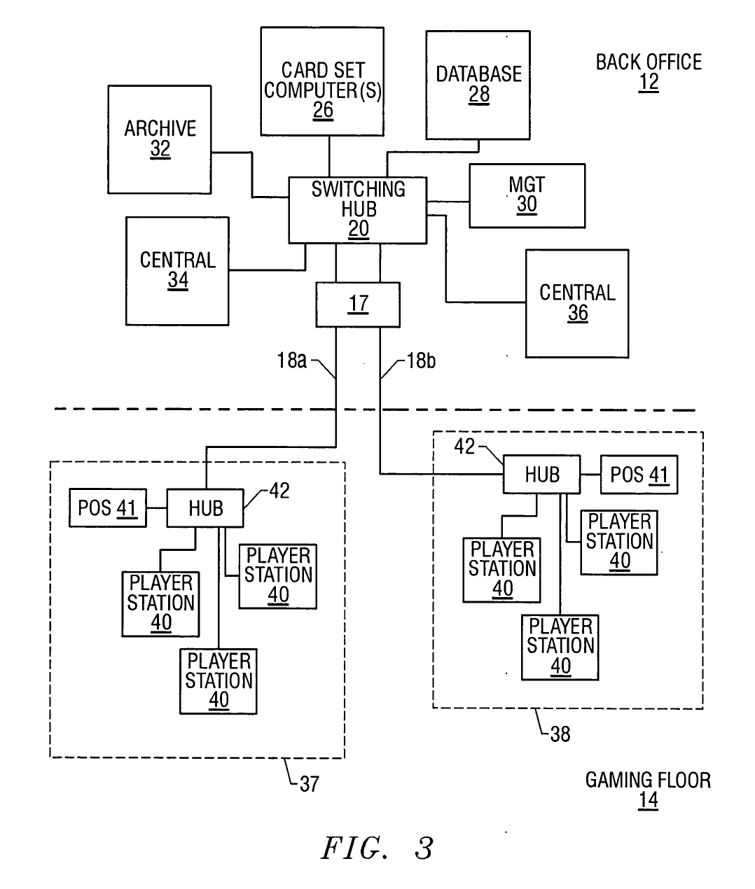

FIG. 3 shows further detail of a single gaming establishment component 11. As shown in FIG. 3, a secure communications arrangement facilitates communications between back office system 12 and gaming floor system 14. Security may be enhanced with hardware firewalls 17 connected in the communications lines 18a and 18b which extend to gaming floor system 14 and/or by firewall software operating on the various computers that make up back office system 12.

Back office system 12 includes a number of separate processing devices interconnected through a suitable communications arrangement. In the illustrated form of the invention, back office system 12 comprises a local area network of individual processing devices and includes a switching hub (network switch) 20 to which each separate processing device connects. The two floor system communication links 18a and 18b also connect into switching hub 20.

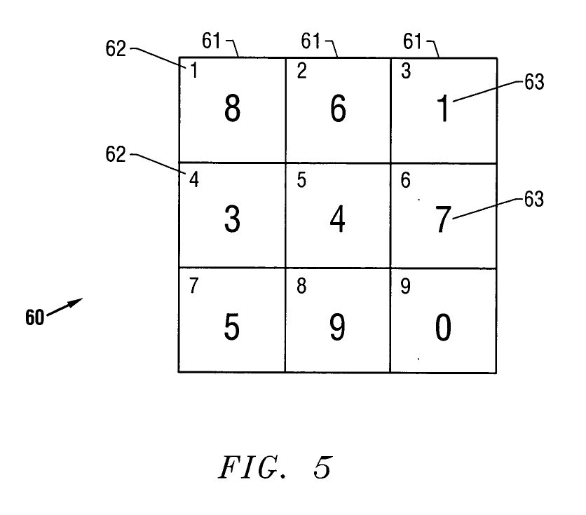

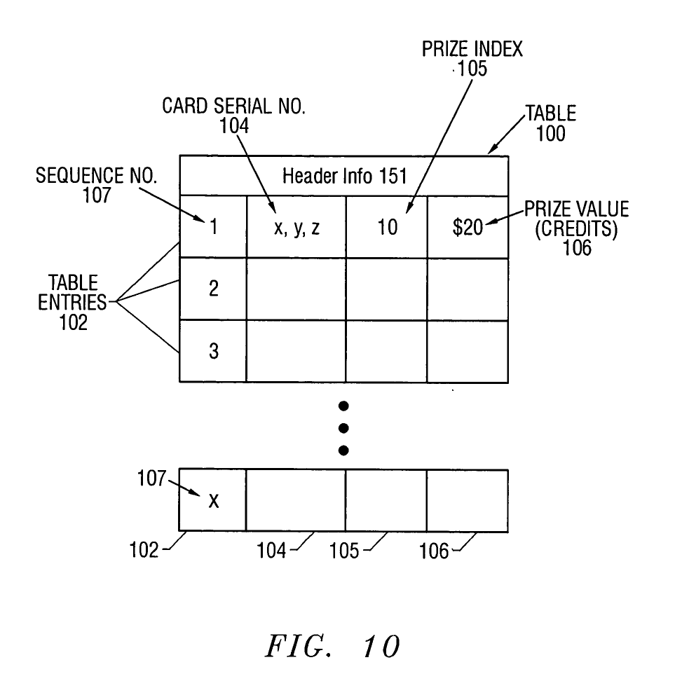

The illustrated preferred form of back office system 12 shown in FIG. 3 includes one or more card set computers 26, a database computer 28, a management computer 30, an archive computer 32, and two separate central computers or processors 34 and 36. Card set computer 26 produces and stores one or more matched card sets, each matched card set including a number of game play records. Each game play record corresponds to an individual card representation in a set of card representations used in creating the matched card sets. The matched card sets, or rather, data representing the matched card sets, are stored in a suitable storage device (not shown) associated with or accessible by card set computer 26 until a new or unused set is requested by one of the central computers 34 or 36. At that time, at least one matched card set is communicated to the requesting central computer. Card set computer 26 may also be used to manufacture the set or sets of card representations to be used in the system. Alternatively, one or more sets or perms of card representations may be generated elsewhere and stored in card set computer 26 to be used in producing the desired matched card sets. It will be noted that the invention requires only a single set of card representations to be used in creating numerous matched card sets; however, different sets of card representations may be used to create matched card sets within the scope of the present invention. The structure of the individual card representations will be discussed further below with reference to FIG. 5 and the structure of the matched card sets and game play records will be discussed below with reference to FIG. 10.

In the preferred form of the invention shown in FIG. 3, card set computer 26 may also control a local object draw device or other game designation generating device (such as device 16′ shown in FIG. 2) and receive sets of game designations from that device. Where software code is executed to generate the required sets of game designations, the game designation generation code may be executed by card set computer 26. As a further alternative, the object draw or other device may include its own dedicated controller or processor which supplies sets of game designations to card set computer 26. In the implementation of the invention shown in FIG. 1, card set computer 26 may receive sets of game designations from the remote game designation generating component (16 in FIG. 1) through any suitable communications arrangement or through physically distributed media such as tapes, compact disks, removable hard disks, or integrated circuit memory devices, for example.

Each central computer 34 and 36 is programmed to communicate with card set computer 26, database computer 28, and with a particular group of gaming floor devices. FIG. 3 shows two separate groups of gaming floor devices, group 37 and group 38, for purposes of example. Central computer 34 is programmed to communicate with each of the gaming floor devices in group 37, while central computer 36 is programmed to communicate with each of the gaming floor devices in group 38.

Each central computer 34 and 36 stores data representing one or more matched card sets provided from card set computer 26 for use by the gaming floor devices as described below. Each central computer 34 and 36 also receives information from the various gaming floor devices in the respective group. Some of this information is stored in database computer 28. For example, central computer 34 receives bingo card requests and game play requests from devices in group 37. Central computer 34 also responds to the bingo card requests and game play requests received from devices in group 37.

The multiple central computer arrangement shown in FIG. 3 provides several advantages. First, in the event that one of the central computers 34 or 36 experiences a technical problem which prevents it from operating properly, only a single group of gaming floor devices is affected. Second, the multiple central computer arrangement shown in FIG. 3 is readily scalable to increase or decrease the number of gaming floor devices supported by the system. Furthermore, the multiple central computer arrangement allows faster communications with the gaming floor devices and therefore increases the speed at which a player may play the game or games offered through gaming system 10.

Database computer 28, along with its associated data storage device or devices (such as one or more hard drives accessible to the database computer for example), serves as a data storage repository for storing all player records and system usage information. Most importantly for the present invention, database computer 28 stores databases that may be used by the system. in servicing bingo card requests and game play requests. Database computer 28 may also collect and store usage information indicating the gaming floor devices players have used, and the extent of use.

Numerous different database structures for use in database computer 28 will be apparent to those of ordinary skill in database development and application. The invention encompasses any suitable database structure for maintaining the player and other information required in the operation of the gaming system 10.

Management computer 30 operates under the control of management software to provide system reports including real-time reports and system usage and performance reports of interest to the system operators, managers, or regulators. The software executed at management computer 30 also may be used to schedule administrative functions required or helpful for the database computer system 28. Management computer 30 may include a suitable display for providing a user interface and for displaying reports and other information. Although not shown in FIG. 3, a printer may also be included in the back office portion of the network or may be connected directly to management computer 30 for printing system reports and usage records.

In the preferred form of the invention, central computers 34 and 36 send used matched card sets back to card set computer 26. Card set computer 26 then periodically sends the used matched card sets to archive computer 32 which serves as a repository for used matched card sets. Archive computer 32 is also preferably used to store a copy of each complete unused matched card set as well. These unused matched card set copies and used matched card sets may be archived or stored in any suitable fashion in a nonvolatile memory or storage device associated with the archive computer 32.

Referring now to the gaming floor devices shown in FIG. 3, each group 37 and 38 includes a number of player stations 40 and a point-of-sale or cashier terminal (POS) 41, all connected to a local area network communications hub or switch 42. Although not shown in the figure, each group may also include one or more remote point-of-sale (RPOS) terminals, and one or more kiosks also connected to the communications hub 42. The communications hub 42 of each gaming floor group is connected to hub 20 of the back office system 12 through one of the communications lines 18a or 18b.

So as not to obscure the present invention in unnecessary detail, the following description of the various gaming floor and back office components and their operation will focus on those aspects of the components pertinent to the present invention and will omit other aspects of the components. In particular, game accounting functions and elements of the gaming floor components involved in game accounting will generally be omitted from the following disclosure. It will be appreciated that the present invention is not in any way limited to use with any particular game accounting system. Rather, the present invention may be implemented with cash based accounting systems, cashless systems, or combination cash and cashless systems. Each of these types of accounting systems will require various elements such as card readers, receipt or voucher printers, and/or other elements at the various gaming floor components.

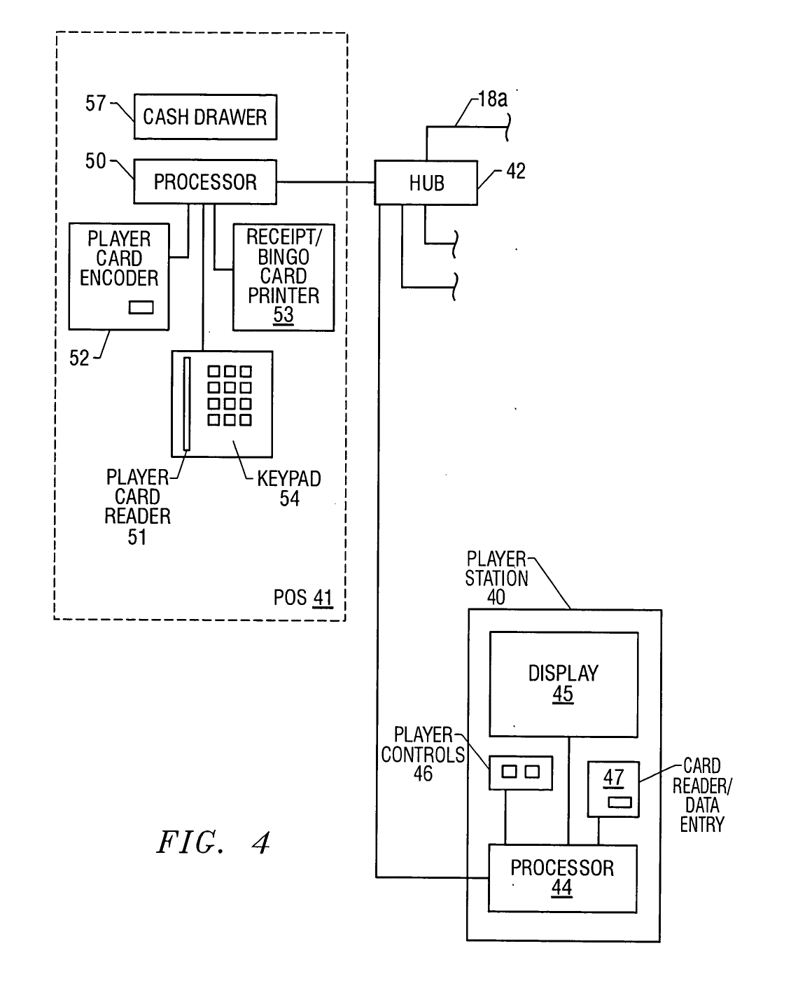

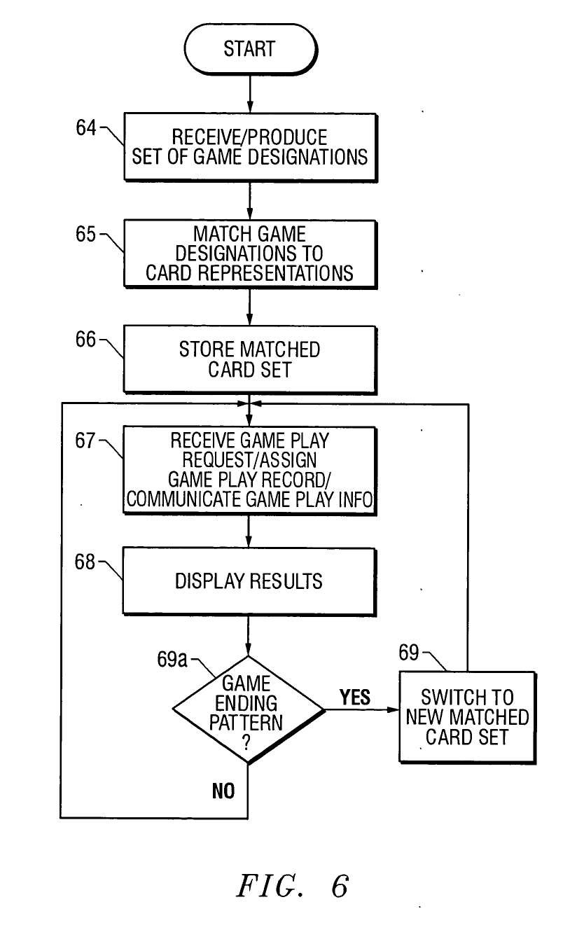

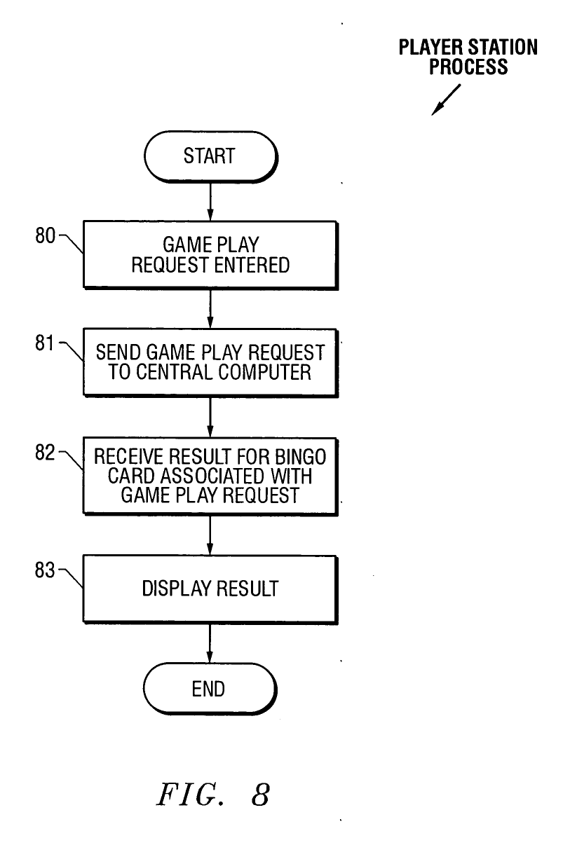

As shown in FIG. 4, each player station 40 may include a processor 44, a touch screen display 45, a control panel 46, and a player card reader/data entry device 47. Player station software executed by processor 44 receives information from player card reader/data entry device 47 to allow the player to participate in the games available through the player station by placing their respective bingo card or cards from the card representation set or sets in play and obtaining the corresponding game play records from one or more matched card sets. The player station software also causes display 35 to show a player the results of play as dictated by the result associated with the game play record corresponding to the card representation which the player has placed in play for a given matched card set. Further information on the operation of the player stations will be described below with reference to FIG. 8. Further information on the assignment of game play records from a matched card set will be described below with reference to FIGS. 6 and 11.

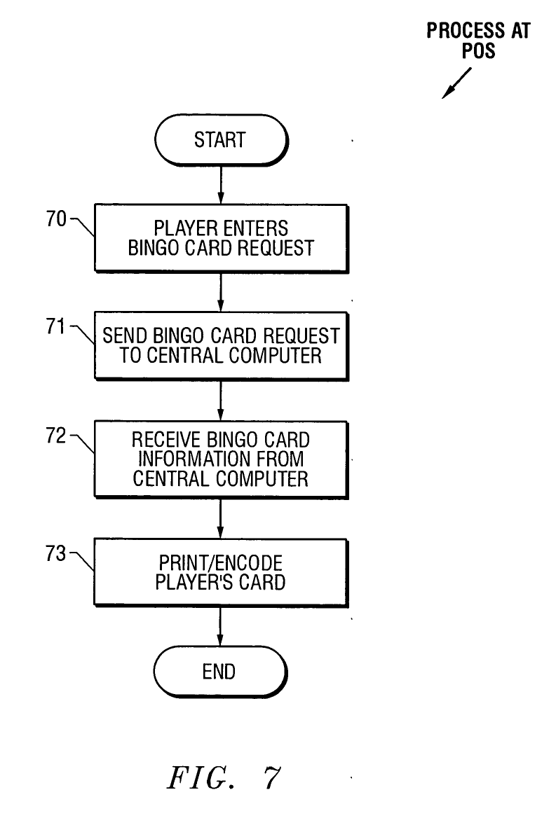

In addition to its functions in the particular gaming accounting system used in system 10, the example POS terminal 41 shown in FIG. 4 enables a player to obtain or purchase one or more card representations which the player may later place in play at a player station 40. In alternative forms of the invention, POS terminal 41 may allow a player to actually initiate a game play request and receive results in the form of a printed ticket or some other form. POS terminal 41 comprises a computer system having a processor 50 and a player/cashier interface including a player card reader 51, player card printer/encoder 52, a receipt/bingo card printer 53, and keypad 54. POS terminal 41 also includes a cash drawer 57 which is accessible by a POS cashier or attendant. Processor 50 included in POS terminal 41 executes operational software to perform the steps described below with reference to FIG. 7.

Referring now to FIG. 5, each card representation comprises a data structure that defines a grid 60 or other arrangement of designations 63. The illustrated grid 60 may be referred to as a nine-spot grid or card having nine separate locations 61 arranged in a three-by-three pattern. It will be appreciated that the grid shown in FIG. 5 is shown only for purposes of example and that the invention is not limited to such a structure. Five-by-five grids or any other suitable arrangements of designations may be used in lieu of the illustrated three-by-three grid. For purposes of example only, the separate locations 61 on the illustrated three-by-three grid are numbered one through nine by the location identifying numbers 62 appearing in the upper left hand corner of each location. Each grid has a random arrangement of card designations 63 positioned at the various locations or spots 61 of the grid. In the illustrated example, card designations 63 comprise Arabic numerals. The designation residing at location 1 comprises the numeral 8 while the designation residing at grid location 2 is the numeral 6, and so forth as indicated in the illustration. The designations associated with the various locations 61 of the grid are selected from a pool of available designations.

Although the physical three-by-three grid is shown for purposes of illustrating a bingo card representation according to the present gaming system 10, it will be appreciated that the grid is actually represented in electronic form for use in the system. The data required to define a given grid or physical card to provide a card representation may be arranged in any suitable fashion. For example, the grid may be represented by a series of the nine numerals with the first numeral in the series representing the designation at location 1, the second numeral in the series representing the designation at location 2 and so forth. In this format, the electronic representation for the grid shown in FIG. 5 will be a representation comprising series of numbers 8, 6, 1, 3, 4, 7, 5, 9, and 0. Each card representation will also preferably include or be associated with a card identifier, serial number, or sequence number which distinguishes that particular card representation from each other card representation in the set.

It will also be appreciated that the invention is not limited to the illustrated designations comprising Arabic numerals. Any type of designation may be used according to the invention. However, the Arabic numeral designations are preferred because they may be conveniently represented in a digital format for processing with the various data processing devices which implement gaming system 10.

In game system 10, players purchase or obtain card representations at a POS terminal 41, or perhaps a player station 40, or perhaps some other element in the system. These purchased or obtained card representations are selected from the set of card representations used to produce matched card sets. Once the player has purchased or obtained a card representation he or she may place it in play at a player station 40, and/or perhaps through some other element of the system such as POS terminal 41. The player places the card representation in play by initiating a game play request which specifies or is otherwise associated with the particular card representation. A specific manner in which a game play request may be associated with a card representation will be discussed below with reference to FIG. 8. Generally, however, each valid game play request causes the system 10 to assign a particular game play record to the player. The particular game play record assigned to the player comprises the game play record corresponding to the card representation (from a particular matched card set) associated with the game play request/requesting player. The result associated with that assigned game play record is determined by the pattern in which the set of game designations for the particular game/matched card set match the designations associated with the particular card representation.

In the following discussion of the operation of a gaming system embodying the principles of the invention, it will be appreciated that references to elements of the system are references to those elements shown in previous figures, particularly FIGS. 1 through 4. Referring to FIG. 6, a gaming method embodying the principles of the present invention may include receiving or generating a set of game designations at a gaming establishment component 11 as indicated at process block 64. A preferred form of the invention then includes matching the set of game designations with card representations included in a set of such card representations as shown at process block 65. This step produces a matched card set that includes a number of game play records. Each game play record corresponds to a different one of the card representations. In a preferred form of the invention, each game play record includes at least a card identifier for the respective card representation, and a result indicator which indicates the result of the game play record, that is, the result of the match between the set of game designations and the particular card representation. The game play record may also include data defining the actual card representation. Details and variations in the game play records will be discussed further below with reference to FIG. 10.

As shown at process block 66 in FIG. 6, the illustrated method further includes storing the data representing the matched card set in a suitable data storage device. In the implementation shown in FIGS. 1 and 3, the steps of receiving/generating the set of game designations, matching the game designations to the card representations to produce the matched card set, and storing the data representing the matched card set are all performed by operational program code executed at card set computer 26. In particular, matching program code performs the matching step and game set storage program code performs the storage step. Where card set computer 26 functions as the designation generating device, it also executes a suitable designation generation program which may invoke a random number generating function to generate the desired set of game designations. Otherwise, card set computer 26 simply includes some arrangement for receiving a set of game designations as needed to produce a matched card set.

In one preferred form of the invention, the process of receiving a set of game designations and producing matched card sets is repeated a number of times at a start of a gaming session to produce a number of matched card sets. The number of matched card sets may be necessary to ensure that the gaming system does not run out of game play records in the course of a gaming session. Also, several different bingo-type games may be in play at any given time in the preferred gaming system, and a different matched card set may be required for each different game in play. In fact, each matched card set represents an individual bingo-type game. In one preferred implementation, a player may have a choice of wager level, one credit, two credits, or three credits for example, where each credit is equivalent to some monetary amount. In this case, game play requests at different wager levels may actually enter the player in different bingo-type games/matched card sets. Different matched card sets are also required to respond to different game play requests associated with the same card representation. That is, a given matched card, set will include only a single game play record corresponding to each card representation in the set of card representations used to produce the matched card set. Once a game play record corresponding to a particular card representation is assigned to a player in the course of play, the next game play record assigned in response to a game play request associated with that same card representation must come from another matched card set.

It will be appreciated that matched card sets may be generated very quickly with current data processing devices and techniques. It may therefore not be necessary to produce and store many different matched card sets for play in the present gaming system. Rather, a matched card set may be produced only as necessary in order to service or respond to play requests initiated by players in the gaming system. In this alternate form of the present invention, the central computer may simply await a game play request by a player, determine if a matched card set is currently available or in play, and if not, generate a new matched card set. The game play request is serviced (a game play record is assigned) from the matched card set that is in play, or if a new matched card set is created, from the new matched card set.

The matched card set storage step 66 in FIG. 6 is performed initially at card set computer 26 in the illustrated system 10. However, the preferred form of the invention utilizing central computers 34 and 36 in FIG. 3 also stores matched card sets in storage associated with the central computers. As discussed further below, the game play records are preferably assigned to players directly from the central computers 34 and 36 rather than from card set computer 26.

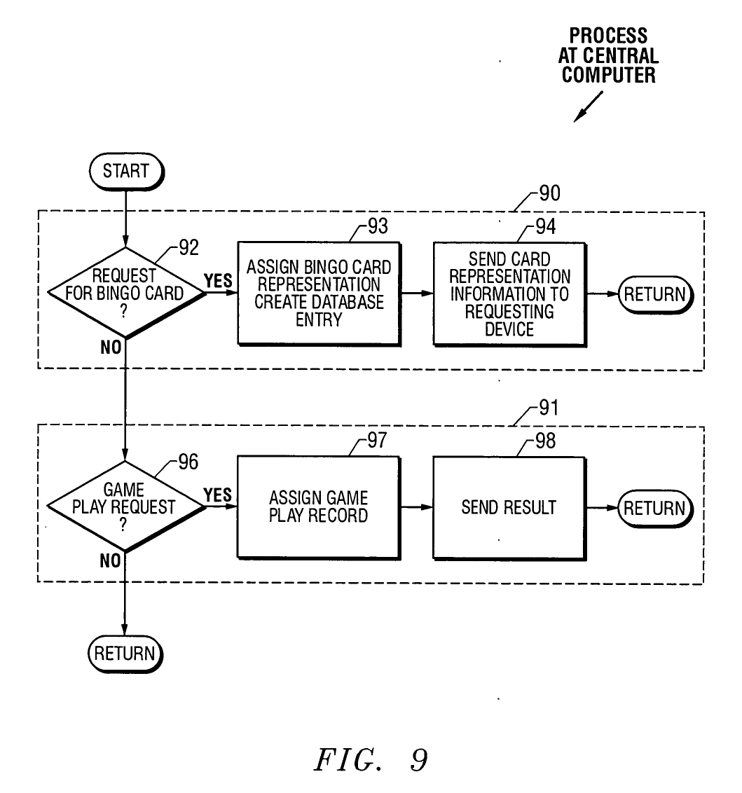

Referring now to process block 67 in FIG. 6, the illustrated method also includes assigning a game play record from an appropriate matched card set in response to a game play request initiated by a player either at a player station 40 (FIG. 3) or perhaps at a POS terminal 41. In the preferred form of the invention, this assignment step is performed by game play assignment program code executed at the central computer (34 or 36 in FIG. 3) receiving the game play request. As will be discussed further below with reference to FIGS. 8 and 9, a central computer, 34 for example, monitors for the receipt of a game play request. If the request is valid, the respective central computer assigns a game play record from the appropriate matched card set to the requesting player as shown at process block 67 in FIG. 6. Sufficient data is then communicated back to the device through which the game play request was initiated to give the player the result of the game play. This data includes a result indicator which may comprise as much as data sufficient to define the card representation corresponding to the assigned game play record together with the designation set used in the matching step 65, or as little as a code for indicating the result. Regardless of the manner in which the game play result is communicated to the player, the method includes the step of displaying the result associated with the game play to the player as shown at step 68. The manner in which the result may be displayed is discussed below with reference to FIGS. 7 and 8.

The form of the invention illustrated in FIG. 7 includes monitoring for a game play request associated with a card representation that achieves a game ending winning pattern in the respective matched card set. This monitoring may be performed under the control of game ending play monitoring program code which preferably detects an indicator in the assigned game play record to identify whether the result is for a game ending pattern or otherwise. If the assigned game play record corresponds to a bingo card representation that is not matched in a predetermined game ending pattern, as indicated by the inquiry at decision block 69a in FIG. 7, the process loops back to the point above the game play record assignment step (67) and the system waits for the next game play request. However, if the assigned game play record corresponds to a bingo card representation matched in the game ending pattern, the process preferably, but not necessarily, includes switching to a new bingo-type game represented by a new matched card set as indicated at process block 69 to effectively withdraw that matched card set from further play. This switching is preferably performed under the control switching program code executed by a suitable processing device in the system. After switching to the new matched card set, the method includes simply waiting for the next game play request. It will be noted that there may be unassigned matched card representations remaining in the matched card set after the game play record corresponding to the card representation having the game ending pattern has been assigned and is held by a player. Any of these unassigned matched card representations and corresponding game play records are preferably disregarded by the system and are not used.

FIGS. 7 and 8 illustrate the processes performed at the gaming floor devices shown in FIGS. 3 and 4 with respect to the present invention, while FIG. 9 illustrates the processes performed at a central computer 34 or 36 shown in FIG. 3. In the preferred implementation of the invention shown in FIG. 3, each of the gaming floor devices cooperate with a particular central computer, and thus it is necessary to refer to a particular central computer when describing the game floor device processes. For purposes of example, all of the processes described with reference to FIGS. 7 and 8 will refer specifically to central computer 34; however, it will be appreciated that the other central computers cooperate with their respective gaming floor devices in the same fashion. Similarly, FIG. 9 will be described with reference to central computer 34 in order to simplify the discussion, although the identical processes are performed by each central computer in the system.

FIG. 7 illustrates the various processes performed at the POS terminals 41 shown in FIGS. 3 and 4. The primary function performed through POS terminals 41 for purposes of the present invention is to enable players to purchase or obtain bingo cards or bingo card representations for later use in making game play requests in the system. As shown at process block 70 in FIG. 7, player enters a bingo card request at POS 41 either by operating controls associated with the POS themselves or by making a request to a POS operator or cashier. Regardless of how the bingo card request is entered at POS 41, the POS communicates the request to the respective central computer system, central computer 34 in our example, as shown at process block 71. Central computer 34 responds to this communication by assigning bingo card representations in the process described below with reference to FIG. 9, and then sends bingo card assignment information back to the POS 41 through which the request was entered. The respective POS 41 receives the bingo card assignment information as shown at process block 72 and then uses this information to print, encode, or otherwise produce a player's bingo card as shown at process block 73. The player's bingo card (or simply “player's card”) preferably comprises some physical card that enables the player to later place one or more bingo card representations in play in a game offered through the present invention.

The specific manner in which the steps shown in FIG. 7 are performed may vary widely within the scope of the present invention from one implementation to the next. For example, some systems may require that every game play request made by a player be associated with a different bingo card representation whereas other systems may allow a player to place the same bingo card representation in play in one game play request after another. Depending upon which of these system rules apply, the step of entering a bingo card request at process block 70 in FIG. 7 may include an indication of the number of bingo card representations the player wishes to obtain. Alternatively, where a player may or must obtain a number of bingo card representations at POS 41, the POS may go through the separate steps shown in FIG. 7 for each bingo card representation.

The nature of the communications required in the steps shown at process blocks 71 and 72 may also vary widely within the scope of the invention. It will be appreciated that any suitable communications technique and protocol may be used to facilitate the communications. One preferred system uses TCP/IP communications. Also, the data that must be communicated depends upon the manner in which the system is implemented. For example, the bingo card assignment information received at process block 72 may include simply bingo card identifiers or serial numbers or the entire set of data required to define each bingo card. An example of this data for defining a bingo card is described above with reference to FIG. 5. Also, where the players are assigned cards in a set sequence from the bingo card or card representation set, a communication identifying the bingo card representations assigned to the player may include a starting sequence identifier from the bingo card representation set and a value representing the number of bingo card representations to be assigned. Where bingo card identifiers, serial numbers, or sequence numbers are used, and where the player bingo card includes representations of the assigned cards or all of the data required to define a card, POS 41 may be required have access to a bingo card representation data set or perm that correlates the various card identifiers, serial numbers, and/or sequence numbers to the data required to define the respective card.

The player's bingo card produced at process block 73 in FIG. 7 may also take many forms within the scope of the present invention. In one form of the invention, a printer at POS 41 prints a separate card for each bingo card representation requested by the player, and each such card includes a reproduction of the respective bingo card. Preferred forms of the invention will, in addition to or in lieu of the actual representation of the bingo card, print or record on the player's card a card identifier, serial number, or sequence number, or the set of data required to define the bingo card. This information may be printed in bar code form, on magnetic media, or in any other suitable machine readable form. However, other forms of the invention will print the actual card identifier, serial number, or sequence number that identifies the card and require that the player manually enter the identifier to place the card in play.

The discussion above refers to POS 41 as the element in the gaming system at which a player purchases or obtains bingo card representations to place in play according to the invention. However, it will be appreciated that certain implementations of the invention may allow a player to purchase or obtain their bingo card representations at player stations 40. Thus, the process steps shown in FIG. 7 may in fact be performed at player stations 40.

Referring now to FIG. 8, in addition to obtaining or purchasing bingo card representations as may be possible through player stations 40 the preferred process at a player station 40 requires a player to enter a game play request as indicated at process block 80. This game play request may be entered in any number of fashions through suitable player controls associated with the respective player station. Since a game play request according to the invention ultimately has the effect of entering a bingo card representation in a bingo game according to the invention, the step of entering a game play request may include steps allowing or requiring the player to identify a particular bingo card representation in the event the player has obtained or purchased multiple such bingo cards.

In response to the player's entry of a game play request, player station 40 communicates the game play request to the respective central computer as indicated at process block 81. The information included in this communication of the player's game play request at least includes sufficient information for the central computer to identify a bingo card representation being placed in play. This information may include at one extreme the entire set of data required to define the bingo card representation and at the other extreme a card identifier, serial number, or sequence number, or even a player station identifier. Also, where the player has been assigned only a single bingo card, an identifier for the player or possibly the player's player station has the effect of defining the bingo card representation being placed in play.

In response to the forwarded game play request, the central computer system assigns a result corresponding to the bingo card representation placed in play from a matched card set as described below with reference to FIG. 9. Player station 40 then receives this communication from the central, 34 in this example, as indicated at process block 82. The result may be communicated in the form of a result code, a prize value, or data sufficient to define the result of the matching between the respective bingo card representation and the designation set (ball draw) used for the respective matched card set. The process according to the invention may also include communicating the entire designation set to player station 40 in addition to or in lieu of the result. Where the result itself is not communicated to player station 40, the player station may then use the designation set to identify the pattern matched for the bingo card placed in play and from that information obtain the result or prize for the game play. The result or prize may be looked up in data stored at player station 40 or at some other element in the system.

Regardless of how the result of the game play is identified or obtained at player station 40, the process at the player station includes displaying the result as indicated at process block 83 in FIG. 8. The steps involved in displaying the result associated with a game play record as indicated at process block 83 may vary significantly within the scope of the invention. For example, player station 40 may actually display the grid or another arrangement representing the bingo card and allow the player to daub the card. It is noted that since the game play request for which the result was returned was associated with the bingo card representation and thus the card structure or at least an identifier for the card structure was known at player station 40 at the time the game play request was generated. Daubing the card in this case would require matching designations on the grid to designations included in the respective set of game designations for the particular bingo-type game. This matching could be performed by the player at player station 40 or could be performed by the system in response to a daubing request entered by the player in some fashion. The daubing would allow the player to identify whether there are any patterns of matching designations which represent a win in the particular game. Player station 40 may also be programmed to notify the player of winning patterns matched on the graphical card representation and prompt them to daub either manually or by entering a daub request to allow the system to daub the bingo card representation in play. Daubing a graphical representation of a bingo card at a player station may be thought of as manual daubing whether the daubing is performed by the player or performed by the player station or some other element of the system at the request of the player. Also, in addition to a manual daubing step, a gaming system according to the invention may require a separate input by the player to claim the bingo prize or result associated with the game play request. Again the player may be prompted by the player station to make any additional prize or result claiming action or input prior to displaying the result at process block 83.

Alternatively to this manual daubing and any additional prize or result claiming inputs at player station 40, a gaming system according to the present invention may rely on the matching of designations previously performed in the process of producing the matched card set. In this mode of play, the game play request for a play entered by the player at player station 40 represents a request for automatic daubing. Since no daubing is required at player station 40, the data communicated from the central computer 34 to the player station need only include a result indicator containing information on whether the corresponding bingo card representation produced a winning or losing pattern when matched with the respective set of game designations. However, it may be desirable to still send to player station 40 data defining the designation set used to produce the matched card set from which the result was taken.

In any daubing or prize claiming arrangements, the result of the game play request, that is, the result associated with the game play record assigned to the player, may be displayed in any number of fashions. For example, the result may be displayed as spinning reels imitating a slot machine. The spinning reels would stop at a point indicating a win or loss according to the result dictated by the game play record corresponding to the player's bingo card representation place in play and according to some predefined meaning of reel designation combinations. As other examples, the results may be displayed as a horse race, poker hand, or in any other desired fashion. In a fully automatic daubing system, the player may not even be aware he or she is playing a bingo-type game.

As shown in FIG. 9, central computer 34 services both the requests for bingo card representations entered through POS terminals 41 or perhaps player stations 40, and the game play requests entered through the player stations or perhaps through the POS terminals. Central computer 34 may also serve an important role in the particular game accounting arrangement employed by a gaming system implementing the present invention. However, as described above, the accounting aspects of the illustrative gaming system are omitted from this disclosure.

The central computer steps associated with servicing a request for a bingo card representation are shown at dashed box 90 in FIG. 9, while the steps associated with servicing a game play request are shown at dashed box 91. Referring first to dashed box 90 if an input received from a floor device is a request for one or more card representations, the process branches from decision block 92 to process block 93. As indicated at process block 92 the central computer system first assigns the number of card representations indicated by the request. The assigned card representation or representations are selected from a card perm which will be used to create matched card sets used in the system. The assignment step may be performed at random from the card perm, or card representations may be taken sequentially from the perm. The manner in which card representations are assigned to players according to the invention may vary widely because the system does not rely on the card assignment procedure for ensuring randomness in the assignment of results. Rather, as in any bingo game, the randomness of game results is produced by matching the randomly distributed card designations on the card representations and the randomly or pseudo-randomly generated designation set. In any event, it may be helpful in certain implementations of the invention to be able to track which players own which card representations. Thus, the bingo card assignment process may include creating a database entry for each assignment correlating card or cards from the perm with the player to whom they are assigned. The database in which this entry is made is preferably maintained at the separate database computer 28 shown in FIG. 3. After the assignment of the card representation or representations, and creation of any database entries at process block 93, central computer 34 communicates the assigned card representation information back to the floor device through with the card representation request was entered. This communication step is shown at process block 94 in FIG. 9. As discussed above with reference to FIG. 8, the information communicated to the requesting floor device in response to a card representation request may vary greatly between implementations of the invention, from information necessary to actually define a card representation to an identification number, serial number, or sequence number. After the assigned bingo card representation is communicated to the requesting floor device, the process at the central computer returns to await another communication from a floor device.

It will be noted from the above discussion that there may be a relatively small number of available bingo card representations in the set used to produce the matched card sets. Yet a gaming facility according to the invention may accommodate a number of players equal to or exceeding the number of card representations included in the card set or perm. In order to service a larger number of players, the present invention may assign the same card representation to multiple players.

As shown at dashed box 91 in FIG. 9, if central computer 34 determines that the communication received from a floor device is a game play request at decision block 96, the central computer assigns a game play record for the game play request as shown at process block 97 and then communicates the assigned result back to the requesting floor device as shown at process block 98. The process then returns to wait for another communication from a floor device.

The steps taken at process block 97 in FIG. 9 will depend upon how matched card sets are made available in the particular implementation of the system. In one preferred implementation, once a result for a given bingo card representation is assigned from a matched card set, an additional matched card set is made available for responding to the next game play request associated with that bingo card representation. Once the result for the same given bingo card representation is assigned from this additional matched card set, yet another matched card set is made available and so on. A given one of the matched card sets made available for play in this implementation may be held open for play until all results are assigned, for a defined or set period of time, or until a game ending winning result is assigned from the matched card set. In this implementation the central computer may maintain a set of pointers for the various card representations in the matched card set. Each pointer would indicate which matched card set should be used for a given game play request associated with a given bingo card representation.

In alternative implementations, each matched card set is opened for play for only a short period of time and then another matched card set is opened for play. Making each matched card set available for play for only a short period of time may ensure that results will be available if the same bingo card representation is placed in play several times in short succession. In this implementation, central computer 34 is not required to keep track of multiple matched card sets available for play at any give point in time. Also, it will be appreciated that even where a different matched card set is made available for play immediately after it is exhausted with respect to a card representation, the matched card sets may still be held open for play for only a set period of time before being closed or withdrawn from play.

As discussed above with reference to FIG. 8, the nature of the communication of the result back to the requesting device may vary greatly within the scope of the present invention. The communication may include one or more distinct sets of information, and multiple sets may be separated in time. The communication may include as little as a result code or identifier. Alternatively, the communication may include the data defining the designation set used to make the matched card set from which the result is assigned either with or without a result code and a prize value in the same or separate communication.

FIG. 10 shows the data representing a matched card set according to one preferred form of the invention. The data is stored in a table 100 including a header 101 identifying the matched card set and distinguishing it from any other card set that is in play or may be created. Header 101 may also include information identifying the matched card set as one to be used for a certain wager level and may further include information identifying or defining the set of game designations used to produce the respective matched card set. Table 100 further includes a number of entries 102, each entry representing a respective game play record in the matched card set and corresponding to a different bingo card representation in the set of bingo card representations used to create the matched card set. Each entry 102 includes an ID field 104 containing a card serial number or other card defining information for the respective bingo card representation which corresponds to the entry. Each entry 102 further includes a prize index field 105, prize value field 106, and sequence number field 107. Prize index field 105 contains a value indicating whether the bingo card representation which corresponds to the entry is a winner or loser for the particular set of game designations with which the representation is matched, while prize value field 106 contains information indicating the value of any prize for the respective matched card representation and thus the prize value of the game play record. Field 107 contains a value for the sequence the respective entry or game play record in the table.

A number of these matched card sets each represented by a different data structure such as table 100 are created and stored at card set computer 26 in the preferred gaming system illustrated in FIG. 3. Matched card sets are then transferred to a central computer, such as computer 34 for example, as necessary. The preferred central computers include program code for monitoring the local store of matched card sets and ensuring that requests for additional matched card sets are issued in time to obtain additional sets before running out of records in the currently stored set or sets. It will be appreciated that the matched card sets may be produced in any suitable fashion and preferably by matching program code executed at the card set computer 26 shown in FIG. 3. The matching program code matches each card representation in a card set to a respective set of game designations to determine the result for that card and fill in the result fields 105 and 106 for the table entry 102 for the respective bingo card representation.

The above described preferred embodiments are intended to illustrate the principles of the invention, but not to limit the scope of the invention. Various other embodiments and modifications to these preferred embodiments may be made by those skilled in the art without departing from the scope of the present invention. For example, although a particular hardware arrangement is shown for purposes of describing the invention, it will be appreciated that numerous hardware arrangements are possible for implementing the present invention. Also, although the operational software-controlled process steps are described as occurring at certain processing elements in the system, the processing steps may be distributed in any suitable fashion over various data processing elements.

1. A method including the steps of:
(a) matching a first set of game designations with a set of bingo card representations to produce a matched card set, the matched card set including a number of game play records with each game play record corresponding to a different one of the bingo card representations and including a result indicator indicating a result of the match between the first set of game designations and the respective bingo card representation;
(b) receiving a number of game play requests, each respective game play request being associated with a respective player and a respective bingo card representation from the set of bingo card representations; and
(c) for each game play request, assigning the respective player the game play record corresponding to the respective bingo card representation with which the respective player is associated.

2. The method of claim 1 further including the steps of:
(a) assigning game play records from the matched card set until a game winning player holds a game play record corresponding to a matched bingo card representation having a game ending pattern; and
(b) withdrawing the matched card set from play in response to the assignment of the game play record corresponding to the matched bingo card representation having the game ending pattern.

3. The method of claim 1 further including the step of matching an additional game designation set with the set of bingo card representations to produce an additional matched card set, the additional matched card set including a number of respective additional game play records with each additional game play record corresponding to a different one of the bingo card representations and including a result indicator indicating a result of the match between the additional game designation set and the respective bingo card representation.

4. The method of claim 3 further including the steps of:
(a) receiving an additional game play request associated with a given player who has already been assigned a respective game play record from the matched card set, the additional game play request also being associated with a respective bingo card representation from the set of bingo card representations; and
(b) assigning the given player the additional game play record corresponding to the respective bingo card representation with which the given player is associated.

5. The method of claim 3 further including the step of assigning additional game play records from the additional matched card set in response to a game play request which next follows a game play request for which is assigned a game ending game play record.

6. The method of claim 3 further including the step of assigning game play records from the matched card set for a set period of time and then assigning additional game play records from the additional matched card set after that set period of time.

7. The method of claim 1 further including the steps of:
(a) matching a number of additional game designation sets with the set of bingo card representations to produce a number of additional matched card sets, each additional matched card set including a number of respective additional game play records with each additional game play record in a given one of the additional matched cards sets corresponding to a different one of the bingo card representations and including a result indicator indicating a result of the match between the respective additional game designation set and the respective bingo card representation; and
(b) storing each additional matched card set so that respective additional game records are available for assignment in response to a respective game play request.

8. A program product stored on a computer readable medium, the program product including:
(a) matching program code for matching a first set of game designations with a set of bingo card representations to produce a matched card set, the matched card set including a number of game play records with each game play record corresponding to a different one of the bingo card representations and including a result indicator indicating a result of the match between the first set of game designations and the respective bingo card representation; and
(b) game play assignment program code for assigning game play records from the matched card set, a respective game play record being assigned in response to a respective game play request, each respective game play request being associated with a respective player and a respective bingo card representation in the matched card set, and the respective game play record assigned for a respective game play request being assigned to the player associated with the bingo card representation with which the game play request is associated.

9. The program product of claim 8 further including:
(a) game ending play monitoring program code for detecting when a player has been assigned a game play record corresponding to a matched bingo card representation having a game ending pattern; and
(b) matched card set switching program code for switching to a different matched card set when the winning play monitoring program code detects that a player has been assigned the game play record corresponding to the matched bingo card representation having the game ending pattern.

10. The program product of claim 8 wherein the matching program code matches an additional game designation set with the set of bingo card representations to produce an additional matched card set, the additional matched card set including a number of respective additional game play records with each additional game play record corresponding to a different one of the bingo card representations and including a result indicator indicating a result of the match between the additional game designation set and the respective bingo card representation.

11. The program product of claim 10 wherein the game play assignment program code responds to a game play request from a given player who as been assigned a game play record from the matched card set by assigning the given player an additional game play record from the additional matched card set, the assigned additional game play record corresponding to the respective bingo card representation with which the given player is associated.

12. The program product of claim 11 wherein the game play assignment program code assigns a respective additional game play record from the additional matched card set in response to a game play request which next follows a game play request for which is assigned a game ending play record from the matched card set.

13. The program product of claim 10 wherein the game play assignment program code assigns game play records from the matched card set for a set period of time and then assigns additional game play records from the additional matched card set after that set period of time.

14. A gaming system comprising:
(a) a number of player stations, each player station for enabling a player to initiate a game play request and for displaying results of a game play upon receipt of a game play record, each game play request initiated by a player being associated with the initiating player and with a respective bingo card representation in a set of bingo card representations;
(b) a central processing system for storing a set of game play records, each game play record corresponding to a respective bingo card representation which has been matched to a first set of game designations, the central processing system also for assigning a respective game play record from the set of game play records to a player in response to a game play request initiated by the respective player at one of the player stations, the respective game play record assigned to the player being the game play record corresponding to the bingo card representation that is associated with that player; and
(c) a communications system operatively connected to the central processing system and to each of the player stations for facilitating communications between the central processing system and each player station.

15. The gaming system of claim 14 wherein:
(a) the central processing system stores a number of additional sets of game play records, each game play record in a respective additional set of game play records corresponding to a respective one of the bingo card representations which has been matched to an additional set of game designations; and
(b) the central processing system also assigns a respective game play record from one of the additional sets of game play records to a player in response to a game play request initiated by the respective player at a respective one of the player stations, the respective game play record assigned to the player from the additional set of game play records being the game play record in that additional set corresponding to the bingo card representation that is associated with that player.

16. The gaming system of claim 16 wherein the matched card set includes a game ending game play record corresponding to a bingo card representation from the set of bingo card representations and wherein the central processing system withdraws the matched card set from play in response to the assignment of the game ending game play record.

17. The gaming system of claim 14 further including a gaming floor component for directing a bingo card request to the central processing system in response to a bingo card request input entered for a respective player, and wherein the central processing system responds to the bingo card request by associating a respective bingo card representation from the bingo card representation set with the respective player for whom the bingo card request input was entered.

18. The gaming system of claim 17 wherein the gaming floor component comprises one of the player stations.

19. The gaming system of claim 17 further including a point of sale terminal distinct from the player stations and wherein the gaming floor component comprises the point of sale terminal.

20. The gaming system of claim 14 wherein the central processing system is also for maintaining a database correlating each of a number of respective players to one or more bingo card representations with which the respective player is associated.
